(19) United States
(12) Patent Application Publication
(10) Pub. No.: US 2025/0233343 A1
(43) Pub. Date: Jul. 17, 2025

(54) CONNECTOR AND MANUFACTURING METHOD THEREOF

(71) Applicant: HL Klemove Corp., Incheon (KR)

(72) Inventors: Kun-Ju KOH, Incheon (KR); Min-Ha LEE, Incheon (KR)

(21) Appl. No.: 18/740,492

(22) Filed: Jun. 11, 2024

(30) Foreign Application Priority Data
Jan. 16, 2024 (KR) 10-2024-0006714

(51) Int. Cl. H01R 13/50; B29C 45/14; B29K 101/12; B29L 31/36; H01R 13/04; H01R 43/24

(52) U.S. Cl. CPC H01R 13/50; B29C 45/14655; H01R 13/04; H01R 43/24; B29K 2101/12; B29L 2031/36

(57) ABSTRACT

A connector may include: at least one electrically conductive connector pin; a pre-mold formed such that the connector pin penetrates the pre-mold and both ends of the connector pin respectively protrude from a first surface and a second surface of the pre-mold; and a housing configured to expose at least one end of the connector pin to outside and accommodate the pre-mold therein, wherein the housing has a shape surrounding the pre-mold in all directions.

### CROSS-REFERENCE TO RELATED APPLICATION(S)

This application is based on and claims priority under 35 U.S.C. § 119 to Korean Patent Application No. 10-2024-0006714, filed on Jan. 16, 2024, in the Korean Intellectual Property Office, the disclosure of which is incorporated by reference herein in its entirety.

### BACKGROUND

### 1. Field

The disclosure relates to a connector and a manufacturing method thereof, and more particularly, to a connector capable of forming a waterproof structure through a simple structure, and a manufacturing method thereof.

### 2. Description of the Related Art

In general, vehicles include an electronic controller such as Electronic Control Unit (ECU) for electronically controlling various devices. The electronic controller receives information from sensors or switches installed in the respective parts of the vehicle. The electronic controller improves the ride comfort and safety of the vehicle or performs various electronic controls for providing various convenient functions to the driver and passengers by processing the received information.

For example, the electronic controller such as ECU that controls the states of the vehicle's engine, automatic transmission, Anti-Lock Brake System (ABS), etc. through a computer functions to control all parts of the vehicle, such as the driving system, braking system, and steering system, as well as controlling the automatic transmission, with the advancement of vehicles and computers.

The electronic controller is generally detachably connected through a connector for ease of assembly and maintenance.

The connector needs to be waterproofed for protection from moisture because the connector is easy to be exposed to moisture such as rainwater while the vehicle travels.

A male connector of which the connector pins are exposed to the outside is generally manufactured by insert-injecting the connector pins into a connector mold. At this time, adhesive interfaces are made between the connector pins plated with nickel, gold, etc. and plastic of the connector mold, which makes it unable to perform the waterproof function.

Existing waterproof connectors have secured airtightness by potting the connector pins and the plastic.

However, in order to perform the potting, an additional process of injection-molding a connector mold, applying an elastic material such as an epoxy resin for airtightness, and then hardening the resultant structure is required.

### SUMMARY

An embodiment provides a connector capable of forming a waterproof structure through a simple structure, and a manufacturing method thereof.

An embodiment provides a connector of which components are firmly coupled to each other, and a manufacturing method thereof.

An embodiment provides a connector capable of simplifying a production process, and a manufacturing method thereof.

An embodiment provides a connector capable of reducing costs, and a manufacturing method thereof.

Additional aspects of the disclosure will be set forth in part in the description which follows and, in part, will be obvious from the description, or may be learned by practice of the disclosure.

In accordance with an aspect of the disclosure, a connector may include at least one electrically conductive connector pin, a pre-mold formed such that the connector pin penetrates the pre-mold and both ends of the connector pin respectively protrude from a first surface and a second surface of the pre-mold, and a housing configured to expose at least one end of the connector pin to outside and accommodate the pre-mold therein, wherein the housing may have a shape surrounding the pre-mold in all directions.

The housing may be in direct contact with and adhered to all surfaces of the pre-mold.

The pre-mold may be molded by insert-injecting the connector pin.

The pre-mold may be formed of a ThermoPlastic Elastomer (TPE) material.

The housing may be molded by insert-injecting the pre-mold which the connector pin penetrates and is coupled to.

Edges of the pre-mold may be chamfered or rounded.

On an outer surface of the pre-mold, a plurality of convex portions may be provided.

On the outer surface of the pre-mold, a plurality of concave portions may be provided.

The pre-mold may have a shape of which an outer surface is provided with at least one groove.

The connector pin may include at least one protrusion protruding outside the pre-mold in a direction that is perpendicular to an extension direction of the connector pin, and positioned inside the housing.

The protrusion may be provided as at least two protrusions respectively provided outside a first surface of the pre-mold and outside a second surface of the pre-mold.

The housing may include a wall portion surrounding a protruding end of the connector pin.

The wall portion may be formed integrally with the housing.

In accordance with an aspect of the disclosure, a method of manufacturing a connector may include preparing an electrically conductive connector pin, injection-molding a pre-mold such that the connector pin penetrates the pre-mold and both ends of the connector pin respectively protrude from a first surface and a second surface of the pre-mold, and injection-molding a housing configured to expose at least one end of the connector pin to outside and accommodate the pre-mold therein, wherein the housing may have a shape surrounding the pre-mold in all directions.

The injection-molding of the housing may include injection-molding the housing such that the housing is in direct contact with and adhered to all surfaces of the pre-mold.

The injection-molding of the pre-mold may include injection-molding the pre-mold with a ThermoPlastic Elastomer (TPE) material.

The injection-molding of the housing may include molding the housing by insert-injecting the pre-mold which the connector pin penetrates and is coupled to.

The connector pin may include at least one protrusion protruding outside the pre-mold in a direction that is perpendicular to an extension direction of the connector pin, and the injection-molding of the housing may include injection-molding the housing such that the protrusion is positioned inside the housing.

The protrusion may be provided as at least two protrusions respectively provided outside a first surface of the pre-mold and outside a second surface of the pre-mold.

The injection-molding of the housing may include forming a wall portion surrounding a protruding end of the connector pin.

The wall portion may be injection-molded integrally with the housing.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically showing a connector according to an embodiment;

FIG. 2 is a cross-sectional view taken along line A-A of FIG. 1;

FIG. 3 is a perspective view showing a connector pin and a pre-mold according to a first embodiment;

FIG. 4 is a perspective view showing a connector pin and a pre-mold according to a second embodiment;

FIG. 5 is a perspective view showing a connector pin and a pre-mold according to a third embodiment;

FIG. 6 is a perspective view showing a connector pin and a pre-mold according to a fourth embodiment;

FIG. 7 is a perspective view showing a connector pin and a pre-mold according to a fifth embodiment;

FIG. 8 is a front view showing a connector pin and a pre-mold according to a sixth embodiment; and

FIG. 9 is a flowchart illustrating a method of manufacturing a connector according to an embodiment.

### DETAILED DESCRIPTION

Hereinafter, embodiments of the disclosure will be described in detail with reference to the accompanying drawings. The following embodiments are provided to sufficiently transfer the concepts of the present disclosure to one of ordinary skill in the technical art to which the disclosure belongs. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

Hereinafter, an operation principle and embodiments of the disclosure will be described with reference to the accompanying drawings.

### Connector 10

Hereinafter, a configuration of a connector 10 according to an embodiment will be described.

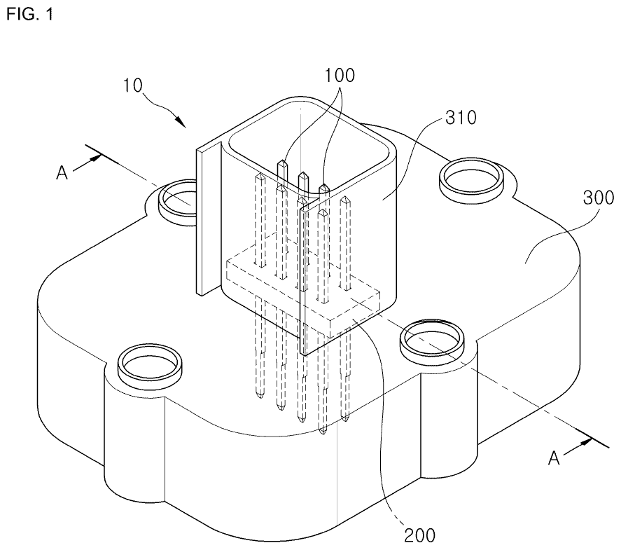

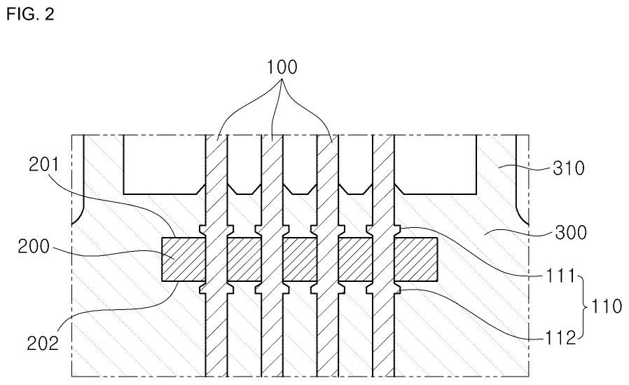

FIG. 1 is a perspective view schematically showing a connector according to an embodiment, and FIG. 2 is a cross-sectional view taken along line A-A of FIG. 1.

The connector 10 according to an embodiment may form a waterproof structure only by injection-molding without potting.

Referring to FIGS. 1 and 2, the connector 10 according to an embodiment may include at least one electrically conductive connector pin 100, a pre-mold 200 which the connector pin 100 penetrates such that both ends of the connector pin 100 protrude from a first surface 201 and a second surface 202, respectively, and a housing 300 which exposes at least one end of the connector pin 100 to an outside of the housing and accommodates the pre-mold 200 therein.

One end of the connector pin 100 may be exposed to the outside to be in contact with a terminal of another connector, specifically, a female connector. Also, another end of the connector pine 100 may be coupled to a substrate (not shown) accommodated in the housing 300 to be electrically connected to the substrate, or may be connected to a separate wire to be electrically connected to an electronic device (not shown) through the wire.

The connector 10 may be provided with a plurality of connector pins 100, and while the connector 10 is coupled to a female connector (not shown), the plurality of connector pins 100 may simultaneously be electrically connected/disconnected to/from the female connector. The plurality of connector pins 100 may have the same shape or have different thicknesses and shapes according to a purpose.

Also, the plurality of connector pins 100 may be arranged at regular intervals or at irregular intervals according to a purpose.

In this case, one ends of the plurality of connector pins 100 exposed to the outside may extend in the same direction to be easily inserted into and in contact with terminals of the female connector while the connector 10 is coupled to the female connector.

The one ends of the plurality of connector pins 100 exposed to the outside may have inclined surfaces to be easily inserted into the terminals of the female connector.

In the embodiment shown in FIG. 0.1, each connector pin 100 may have a cross section being in a shape of a quadrangle and an end being in a shape of a quadrangular pyramid to be easily inserted into a terminal of the female connector. However, the disclosure is not limited thereto, and an end of the connector pin 100 may have a round shape or a planar shape.

According to an embodiment, the connector pin 100 may penetrate the pre-mold 200. One end of the connector pin 100 may protrude from the first surface 201 of the pre-mold 200, and another end of the connector pin 100 may protrude from the second surface 202 of the pre-mold 200.

In this case, the first surface 201 and the second surface 202 may face opposite directions as shown in FIG. 2. However, the disclosure is not limited thereto, and the first surface 201 and the second surface 202 may face directions that are perpendicular to each other or may face the same direction. In this case, the connector pin 100 may have a curved shape such that both ends of the connector pin 100 respectively protrude from the first surface 201 and the second surface 202.

For example, in the case in which the first surface 201 and the second surface 202 face the directions that are perpendicular to each other, the connector pin 100 may have a ‘L’-shaped curved shape inside the pre-mold 200 such that one end of the connector pin 100 protrudes from the first surface 201 and another end of the connector pin 100 protrudes from the second surface 202.

Also, in the case in which the first surface 201 and the second surface 202 face the same direction, the connector pin 100 may have a ‘U’-shaped curved shape inside the pre-mold 200 such that one end of the connector pin 100 protrudes from the first surface 201 and another end of the connector pin 100 protrudes from the second surface 202.

In the case in which the connector 10 includes the plurality of connector pins 100, the plurality of connector pins 100 may be fixed at preset positions by penetrating the pre-mold 200.

According to an embodiment, the pre-mold 200 may be formed of a ThermoPlastic Elastomer (TPE) material. Preferably, the pre-mold 200 may be formed by injection-molding with a TPE material.

The pre-mold 200 may be formed of a TPE material to secure adhesion with the connector pins 100 positioned by penetrating the pre-mold 200. The TPE material may be injection-molded by applying heat thereto, and the TPE material cooled after being injected may show high elasticity characteristics.

The pre-mold 200 may secure adhesion with the connector pins 100 penetrating the pre-mold 200, and may guide the positions of the connector pins 100 inside the housing 300 while the housing 300 is molded.

The housing 300 may form an appearance of the connector 10, while forming a frame in which one ends of the connector pins 100 are exposed to the outside and fixed to be coupled to a female connector.

The housing 300 may be formed of an electrically insulating material such as a synthetic resin.

In this case, the housing 300 may have a shape surrounding all surfaces of the pre-mold 200. According to an embodiment, because the pre-mold 200 is formed of a TPE material to have elasticity, the housing 300 which surrounds all the surfaces of the pre-mold 200 may maintain an appearance of the connector 10 and fix the connector pins 100 at preset positions.

Particularly, as shown in FIG. 2, the housing 300 may be in contact with and adhered to all surfaces of the pre-mold 200, including the first surface 201 and the second surface 202 of the pre-mold 200. According to an embodiment, the housing 300 may be molded by insert-injecting the pre-mold 200 which the connector pins 100 penetrate and are coupled to. Insert-injecting the pre-mole 200 includes molding the pre-mold 200 on the connector pins 100.

By insert-injecting the pre-mold 200 upon molding of the housing 300, the pre-mold 200 may be re-melted by injection temperature, and interfaces between the pre-mold 200 and the housing 300 and between the pre-mold 200 and the connector pins 100 may be adhered to each other, and inside of the connector 10 may be blocked from an external environment, thereby forming a waterproof structure.

The connector 10 according to an embodiment may form a waterproof structure through a simple manufacturing process by insert-injecting the housing 300 including the pre-mold 200 which the connector pins 100 penetrate and which is formed of a TPE material. Insert-injecting the housing 300 includes molding the housing 300 on the pre-mold 200 penetrated by the connector pins 100.

Meanwhile, preferably, the connector 10 according to an embodiment may include a structure for firmly adhering components to fix the components because the pre-mold 200 having elasticity and formed of a TPE material is accommodated inside the housing 300.

The connector pins 100 according to an embodiment may include at least one protrusion 110 protruding outside the pre-mold 200 in a direction that is perpendicular to an extension direction of the connector pins 100, and positioned inside the housing 300.

The protrusion 110 may protrude outside the pre-mold 200, that is, at a location of contacting the housing 300 in the direction (a left-right direction of FIG. 2) that is perpendicular to the extension direction (an up-down direction of FIG. 2) of the connector pins 100.

The housing 300 may be injection-molded in such a way as to accommodate the protrusion 110 therein, and thereby, each connector pin 100 may be firmly coupled to the housing 300 by the protrusion 110.

Meanwhile, according to an embodiment, at least two protrusions 110 may be respectively provided outside the first surface 201 and the second surface 202 of the pre-mold 200. As shown in FIG. 2, each connector pin 100 may be firmly coupled to the housing 300 by penetrating the pre-mold 200 and including a first protrusion 111 protruding outside the first surface 201 and a second protrusion 112 protruding outside the second surface 202.

According to an embodiment, the pre-mold 200 may be molded by insert-injecting the connector pin 100. As such, by insert-injecting the connector pins 100, the plurality of protrusions 110 may be positioned on the first surface 201 and the second surface 202 of the pre-mold 200, and the connector pins 100 may be in close contact with the pre-mold 200.

According to an embodiment, the first protrusion 111 and the second protrusion 112 may be configured as a pair of protrusions protruding in opposite directions to thereby be firmly fixed to the housing 300.

According to an embodiment, one side of the protrusion 110 toward one end of the corresponding connector pin 100 may have a surface that is perpendicular to the extension direction of the connector pin 100, and another side of the protrusion 110 toward the pre-mold 200 may have a surface having a preset angle with respect to the extension direction of the connector pin 100. Accordingly, the protrusion 110 may have a cross section being in a shape of a trapezoid.

Because the protrusion has a cross section being in a shape of a trapezoid, a molding material may be easily injected while the housing 300 is injection-molded, and accordingly, a coupling portion of the connector pin 100 with the housing 300 may be firmly formed.

Also, according to an embodiment, because the protrusion 110 protrudes outside the pre-mold 200, a position of the connector pin 100 may be easily aligned while the pre-mold 200 insert-injects the connector pin 100 in a process of manufacturing the connector 10, and the connector pin 100 penetrating the pre-mold 200 may be prevented from moving relative to the pre-mold 200.

The housing 300 according to an embodiment may include a wall portion 310 surrounding the protruding end of the connector pin 100.

The wall portion 310 may surround the protruding end of the connector pin 100 to protect the connector pin 100, and provide a frame to enable a female connector to be coupled to the connector pin 100.

The wall portion 310 may surround one end of the connector pin 100 to form a coupling space where the connector pin 100 protrudes, and by inserting a female connector into the coupling space, the connector pin 100 may become in contact with a terminal of the female connector. At this time, a housing of the female connector may be coupled to the wall portion 310 to maintain the contact between the connector pin 100 and the terminal. For example, the housing of the female connector may be coupled to the wall portion 310 by causing an outer surface of the housing of the female connector to become in contact with the wall portion 310 by friction, inserting a latch provided in the housing of the female connector into a groove of the wall portion 310, or coupling a protrusion provided in the housing of the female connector to a clip provided in the wall portion 310.

According to an embodiment, the wall portion 310 may be formed integrally with the housing 300, and the wall portion 310 may be injection-molded integrally with the housing 300.

As such, by injection-molding the wall portion 310 integrally with the housing 300, a manufacturing process of the connector 10 may be simplified and manufacturing costs may be reduced.

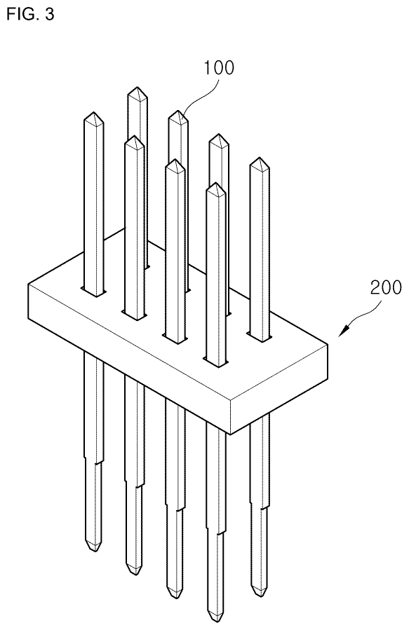

FIG. 3 is a perspective view showing a connector pin and a pre-mold according to a first embodiment.

Referring to FIG. 3, a connector pin 100 and a pre-mold 200 according to a first embodiment are shown.

According to the first embodiment, a plurality of connector pins 100 may penetrate the pre-mold 200 at preset positions, as described above. FIG. 3 shows an embodiment in which eight identical connector pins 200 are arranged in two rows. However, the disclosure is not limited thereto, and the connector pins 200 may have different sizes, a larger number of connector pins 100 may be provided, or the connector pins 100 may be arranged in a row or irregularly.

The pre-mold 200 may be in a shape of a rectangular parallelepiped, the plurality of connector pins 100 may penetrate the pre-mold 200, and the housing 300 may be insert-injected to the outer sides of the pre-mold 200. Meanwhile, FIG. 3 shows the pre-mold 200 being in a shape of a rectangular parallelepiped. However, the disclosure is not limited thereto, and the pre-mold 200 may have another shape according to factors, such as a shape of a connector, an arrangement of pins, a manufacturing process. etc.

As described above, the pre-mold 200 may secure adhesion with the connector pins 100 penetrating the pre-mold 200, and guide the positions of the connector pins 100 inside the housing 300 while the housing 300 is molded.

Meanwhile, each connector pin 100 may include a protrusion 110 protruding in a direction that is perpendicular to an extension direction of the connector pin 100, which is not shown in FIG. 3.

The protrusion 110 may protrude outside the pre-mold 200, that is, at a location of contacting the housing 300, in the direction (a left-right direction of FIG. 3) that is perpendicular to the extension direction (an up-down direction of FIG. 3) of the connector pin 100.

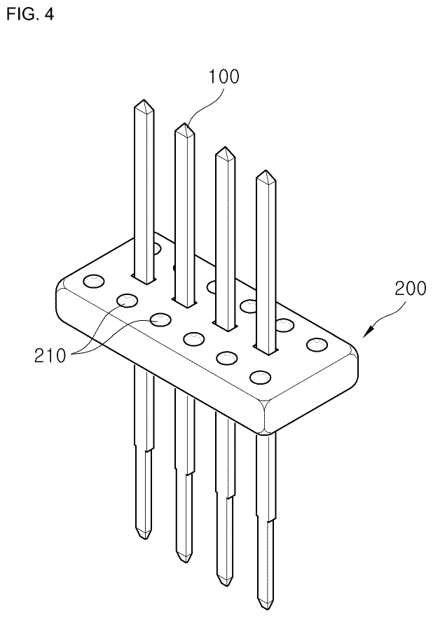

FIG. 4 is a perspective view showing a connector pin and a pre-mold according to a second embodiment.

Referring to FIG. 4, a plurality of connector pins 100 may penetrate a pre-mold 200 according to the second embodiment of the disclosure, as described above. FIG. 4 shows an embodiment in which four identical connector pins 100 are arranged in a row. However, the disclosure is not limited thereto, and the connector pins 200 may have different sizes, a larger number of connector pins 100 may be provided, or the connector pins 100 may be arranged in two rows or irregularly.

Also, the pre-mold 200 according to the second embodiment may include a plurality of convex portions 210 on the outer side.

FIG. 4 shows a case in which the plurality of convex portions 210 are provided on an upper side of the pre-mold 200, that is, on the first surface 210 of the pre-mold 200. However, the disclosure is not limited thereto, and a plurality of convex portions 210 may be provided even on a lower side of the pre-mold 200, that is, on the second surface 202 of the pre-mold 200, or the plurality of convex portions 210 may also be provided even on a side surface of the pre-mold 200.

The plurality of convex portions 210 may increase adhesion between the housing 300 and the pre-mold 200 to firmly couple the pre-mold 200 to the housing 300 while the housing 300 surrounding all surfaces of the pre-mold 200 is injection-molded.

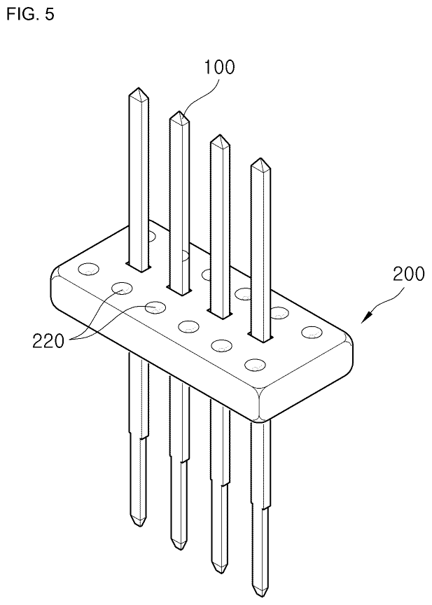

FIG. 5 is a perspective view showing a connector pin and a pre-mold according to a third embodiment.

Referring to FIG. 5, a plurality of connector pins 100 may penetrate a pre-mold 200 according to the third embodiment of the disclosure. FIG. 5 shows an embodiment in which four identical connector pins 100 are arranged in a row. However, the disclosure is not limited thereto, and the connector pins 200 may have different sizes, a larger number of connector pins 100 may be provided, or the connector pins 100 may be arranged in two rows or irregularly.

Also, the pre-mold 200 according to the third embodiment may include a plurality of concave portions 220 on the outer side.

FIG. 5 shows a case in which the plurality of concave portions 220 are provided on an upper side of the pre-mold 200, that is, on the first surface 210 of the pre-mold 200. However, the disclosure is not limited thereto, and the plurality of concave portions 220 may be provided even on a lower side of the pre-mold 200, that is, on the second surface 202 of the pre-mold 200, or the plurality of concave portions 220 may also be provided even on a side surface of the pre-mold 200.

The plurality of concave portions 220 may increase adhesion between the housing 300 and the pre-mold 200 to firmly couple the pre-mold 200 to the housing 300 while the housing 300 surrounding all surfaces of the pre-mold 200 is injection-molded.

Also, the pre-mold 200 according to an embodiment may include all the plurality of concave portions 220 and the plurality of convex portion 210 shown in FIG. 4 on the outer surfaces. For example, the convex portions 210 and the concave portions 220 may be arranged alternately on the outer surfaces of the pre-mold 200, and the convex portions 210 and the concave portions 220 may increase adhesion between the housing 300 and the pre-mold 200 to firmly couple the pre-mold 200 to the housing 300 while the housing 300 surrounding all surfaces of the pre-mold 200 is injection-molded.

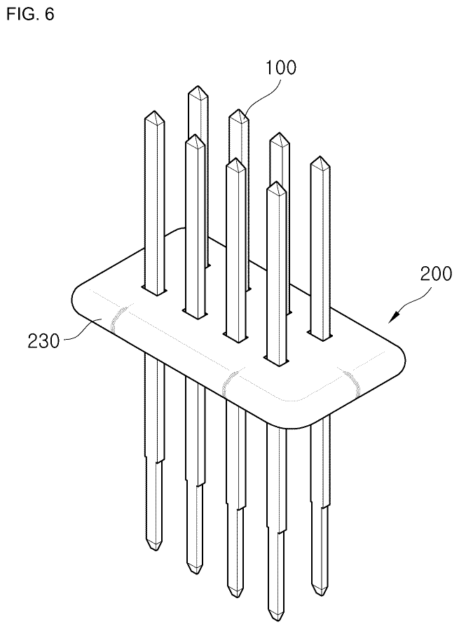

FIG. 6 is a perspective view showing a connector pin and a pre-mold according to a fourth embodiment.

Referring to FIG. 6, according to the fourth embodiment, a plurality of connector pins 100 may penetrate the pre-mold 200 at preset positions as described above. FIG. 6 shows an embodiment in which eight identical connector pins 200 are arranged in two rows. However, the disclosure is not limited thereto, and the connector pins 200 may have different sizes, a larger number of connector pins 100 may be provided, or the connector pins 100 may be arranged in a row or irregularly.

The pre-mold 200 may be in a shape of a rectangular parallelepiped, the plurality of connector pins 100 may penetrate the pre-mold 200, and the housing 300 may be insert-injected to the outer sides of the pre-mold 200.

In this case, the pre-mold 200 may be in a shape of a rectangular parallelepiped with rounded edges.

According to an embodiment, by rounding the edges of the pre-mold 200, a molding material may be easily injected while the housing 300 is injection-molded to the outer sides of the pre-mold 200, thereby raising productivity of the housing 300.

Also, the plurality of convex portions 310 as shown in FIG. 4 or the plurality of concave portions 220 as shown in FIG. 5 may be provided on the outer surfaces of the pre-mold 200, which is not shown in FIG. 6.

Meanwhile, FIG. 6 shows the pre-mold 200 being in a shape of a rectangular parallelepiped. However, the disclosure is not limited thereto, and the pre-mold 200 may have another shape according to factors, such as a shape of a connector, an arrangement of pins, a manufacturing process. etc. The pre-mold 200 having another shape may also include a shape with rounded edges, and due to the rounded edges, a molding material of the housing 300 may be easily injected.

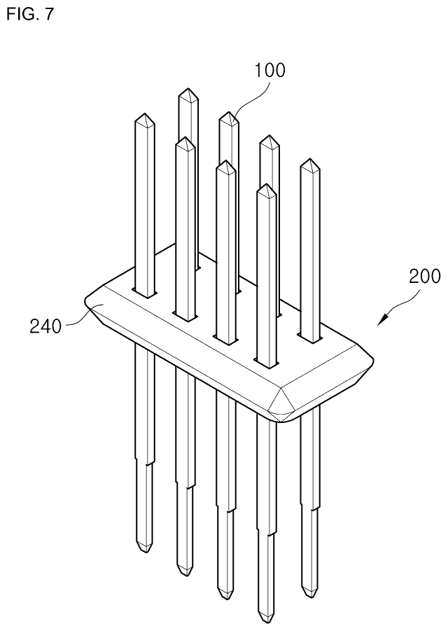

FIG. 7 is a perspective view showing a connector pin and a pre-mold according to a fifth embodiment.

Referring to FIG. 7, according to the fifth embodiment, a plurality of connector pins 100 may penetrate the pre-mold 200 at preset positions, as described above. FIG. 7 shows an embodiment in which eight identical connector pins 200 are arranged in two rows. However, the disclosure is not limited thereto, and the connector pins 200 may have different sizes, a larger number of connector pins 100 may be provided, or the connector pins 100 may be arranged in a row or irregularly.

The pre-mold 200 may be in a shape of a rectangular parallelepiped, the plurality of connector pins 100 may penetrate the pre-mold 200, and the housing 300 may be insert-injected to the outer sides of the pre-mold 200.

In this case, the pre-mold 200 may be in a shape of a rectangular parallelepiped with chamfered edges.

According to an embodiment, by chamfering the edges of the pre-mold 200, a molding material may be easily injected while the housing 300 is injection-molded to the outer sides of the pre-mold 200, thereby raising productivity of the housing 300.

Also, the pre-mold 200 may be in a shape of a rectangular parallelepiped of which some edges are chamfered and the other edges are rounded as shown in FIG. 6.

Also, the plurality of convex portions 310 as shown in FIG. 4 or the plurality of concave portions 220 as shown in FIG. 5 may be provided on the outer surfaces of the pre-mold 200, which is not shown in FIG. 7.

Meanwhile, FIG. 7 shows the pre-mold 200 being in a shape of a rectangular parallelepiped. However, the disclosure is not limited thereto, and the pre-mold 200 may have another shape according to factors, such as a shape of a connector, an arrangement of pins, a manufacturing process, etc. The pre-mold 200 having another shape may also have a shape with chamfered edges, and due to the chamfered edges, a molding material of the housing 300 may be easily injected.

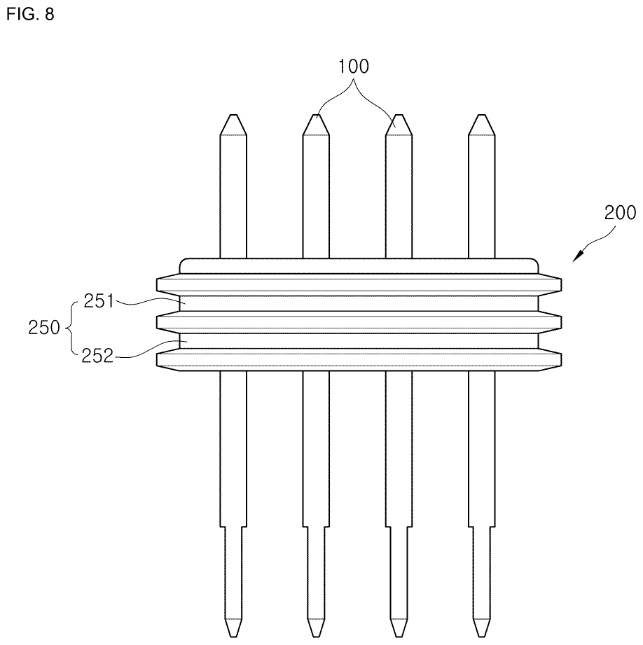

FIG. 8 is a front view showing a connector pin and a pre-mold according to a sixth embodiment.

Referring to FIG. 8, according to the sixth embodiment, a plurality of connector pins 100 may penetrate the pre-mold 200 at preset positions, as described above.

The pre-mold 200 may be in a shape of a rectangular parallelepiped, the plurality of connector pins 100 may penetrate the pre-mold 200, and the housing 300 may be insert-injected to the outer sides of the pre-mold 200.

In this case, at least one groove 250 may be provided in an outer surface of the pre-mold 200.

A plurality of grooves 250 may be provided. FIG. 8 shows a first groove 251 and a second groove 252 formed horizontally in parallel with each other in a side surface of the pre-mold 200. However, the disclosure is not limited thereto, and a groove may also be provided even in the first surface 201 or the second groove 202 of the pre-mold 200.

The grooves 250 may increase adhesion between the housing 300 and the pre-mold 200 to firmly couple the pre-mold 200 to the housing 300, while the housing 300 surrounding all the surfaces of the pre-mold 200 is injection-molded.

Also, the pre-mold 200 according to an embodiment may include the grooves 250 in the side surface, and include the plurality of convex portions 210 as shown in FIG. 4 or the plurality of concave portions 220 as shown in FIG. 5 on the first surface 201 or the second surface 202.

By providing the convex portions 210, the concave portions 220, or the grooves 250 in the outer surfaces of the pre-mold 200, adhesion between the housing 300 and the pre-mold 200 may increase and the pre-mold 200 may be firmly coupled to the housing 300.

### Manufacturing Method of the Connector 10

Hereinafter, a manufacturing method of the connector 10 according to an embodiment will be described.

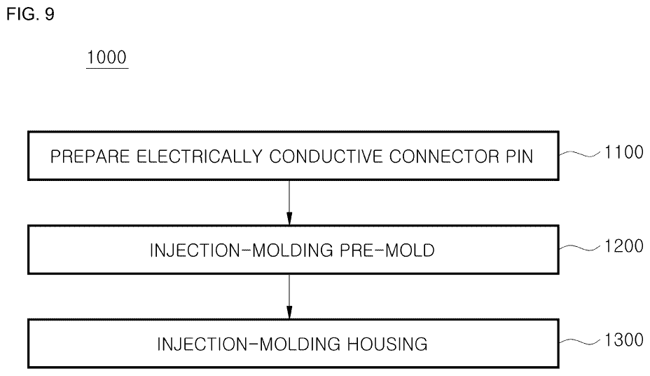

FIG. 9 is a flowchart illustrating a method of manufacturing a connector according to an embodiment.

FIG. 9 illustrates a connector manufacturing method 1000 for manufacturing the connector 10 as described above.

Referring to FIG. 9, an electrically conductive connector pin 100 may be prepared (1100).

A plurality of connector pins 100 may be prepared. In the case in which the plurality of connector pins 100 are provided, the plurality of connector pins 100 may have the same shape or have different thicknesses and shapes according to a purpose.

After the connector pins 100 are prepared, a pre-mold 200 may be injection-molded such that the connector pins 100 penetrate the pre-mold 200 and both ends of the connector pins 100 protrude from a first surface 201 and a second surface 202 of the pre-mold 200 (1200).

As described above, in the case in which the plurality of connector pins 100 are provided, the plurality of connector pins 100 may be arranged at regular intervals or arranged irregularly according to a purpose.

In this case, one ends of the plurality of connector pins 100 exposed to the outside may extend in the same direction.

The pre-mold 200 may be injection-molded such that the plurality of connector pins 100 arranged penetrate the pre-mold 200. One ends of the connector pins 100 may protrude from the first surface 201 of the pre-mold 200, and the other ends of the connector pins 100 may protrude from the second surface 202 of the pre-mold 200.

According to an embodiment, injection-molding the pre-mold 200 may include injection-molding with a TPE material. By injection-molding the pre-mold 200 with a TPE material, adhesion between the pre-mold 200 and the connector pins 100 penetrating the pre-mold 200 may be secured.

Various embodiments in which the connector pins 100 are coupled to the pre-mold 200 by injection-molding the pre-mold 200 are shown in FIGS. 3 to 8.

The pre-mold 200 according to the embodiments shown in FIGS. 3 to 8 may be injection-molded through a mold corresponding to the pre-mold 200.

After the pre-mold 200 is injection-molded, a housing 300 may be injection-molded such that at least one ends of the connector pins 100 are exposed to the outside and the pre-mold 200 is accommodated inside the housing 300 (1300).

The housing 300 may form an appearance of the connector 10 and form a frame in which one ends of the connector pins 100 are fixed while being exposed to the outside to be coupled to a female connector.

The housing 300 may have a shape surrounding all surfaces of the pre-mold 200. Particularly, as shown in FIG. 2, the housing 200 may be in contact with and adhered to all surfaces of the pre-mold 200, including the first surface 201 and the second surface 202 of the pre-mold 200.

To this end, injection-molding the housing 300 (1300) may include insert-injecting and molding the pre-mold 200 which the connector pins 100 penetrate and are coupled to. By insert-injecting the pre-mold 200 upon molding of the housing 300, the pre-mold 200 may be re-melted by injection temperature, and interfaces between the pre-mold 200 and the housing 300 and between the pre-mold 200 and the connector pin 100 may be adhered to each other, and inside of the connector 10 may be blocked from an external environment, thereby forming a waterproof structure.

The connector 10 according to an embodiment may simplify a manufacturing process and form a waterproof structure by insert-injecting the housing 300 including the pre-mold 200 which the connector pins 100 penetrate and which is formed of a TPE material thereinside.

Meanwhile, as described above, each connector pin 100 may include at least one protrusion 110 protruding outside the pre-mold 200 in a direction that is perpendicular to an extension direction of the connector pin 100. In this case, injection-molding the housing 300 (1300) may include injection-molding the housing 300 such that the protrusion 110 is positioned inside the housing 300.

As such, because the housing 300 is injection-molded such that the protrusion 110 is accommodated inside the housing 300, the connector pins 100 may be firmly coupled to the housing 300 by the protrusion 110.

Meanwhile, as described above, the housing 300 may include a wall portion 310 surrounding protruding ends of the connector pins 100.

Accordingly, injection-molding the housing 300 (1300) may include forming the wall portion 310.

At this time, the wall portion 310 may be injection-molded integrally with the housing 300.

As such, by injection-molding the wall portion 310 integrally with the housing 300, a manufacturing process of the connector 10 may be simplified and manufacturing costs may be reduced.

In this way, the connector 10 according to an embodiment may form a waterproof structure through a simple structure, and the method 1000 of manufacturing the connector 10 may simplify a manufacturing process and reduce costs.

### Waterproof Performance of the Connector 10.

Hereinafter, product waterproof performance of the connector 10 manufactured according to the method 1000 of manufacturing the connector 10 will be described.

TABLE 1

| Salt Water Deposition | Leak Amount | Water Resistivity Test (0.4 bar) |
|---|---|---|
| PASS | 0.0138 cc | No Water Inflow |

Table 1 shows product waterproof performance of the connector 10 manufactured according to the method 1000 of manufacturing the connector 10 according to an embodiment, before an environmental test.

Referring to Table 1, the connector 10 according to an embodiment has passed a salt water deposition test and showed a leak amount of 0.0138 cc, and as a result of a water resistivity test, no water inflow has been detected.

The connector 10 manufactured by the manufacturing method 1000 according to an embodiment has been tested under two environments.

First, an environmental test has been conducted under a high-temperature and high-humidity condition.

Product waterproof performance after the connector 10 is exposed to an environment of 85 degrees Celsius and 85% humidity for 1000 hours is shown in Table 2 below.

TABLE 2

| Salt Water Deposition | Leak Amount | Water Resistivity Test (0.4 bar) |
|---|---|---|
| PASS | 0.017 cc | No Water Inflow |

Referring to Table 2, the connector 10 according to an embodiment has passed the salt water deposition test and showed a leak amount of 0.017 cc, and as a result of the water resistivity test at 0.4 bar, no water inflow has been detected.

It is seen that, although the leak amount has been a little increased compared to the performance of the connector 10 before the environmental test, sufficient waterproof performance is maintained.

Second, a thermal shock test has been performed.

Product waterproof performance after exposing the connector 10 to an environment of 125 degrees Celsius for 60 minutes and then exposing the connector 10 to an environment of −40 degrees Celsius for 60 minutes is repeated 1000 cycles is shown in Table 3 below.

TABLE 3

| Salt Water Deposition | Leak Amount | Water Resistivity Test (0.4 bar) |
|---|---|---|
| PASS | 0.038 cc | No Water Inflow |

Referring to Table 3, the connector 10 according to an embodiment has passed the salt water deposition test and showed a leak amount of 0.038 cc, and as a result of the water resistivity test at 0.4 bar, no water inflow has been detected.

It is seen that, although the leak amount is more than that of after the high-temperature and high-humidity test compared to the performances of the connector 10 of before the environmental test and after the high-temperature and high-humidity test, waterproof performance is still maintained.

As such, the connector 10 manufactured according to the method 1000 of manufacturing the connector 10 according to an embodiment may have a simplified process and a simple structure while showing sufficient waterproof performance, and maintain waterproof performance even in a high-temperature and high-humidity environment and thermal shock.

The connector and the manufacturing method thereof according to an embodiment may form a waterproof structure through a simple structure.

In the connector and the manufacturing method thereof according to an embodiment, the components of the connector may be firmly coupled to each other.

The connector and the manufacturing method thereof according to an embodiment may simplify a manufacturing process.

The connector and the manufacturing method thereof according to an embodiment may reduce manufacturing costs.

What is claimed is:

1. A connector comprising:
at least one electrically conductive connector pin;
a pre-mold penetrated by the connector pin such that ends of the connector pin protrude from first and second surfaces of the pre-mold, respectively; and
a housing surrounding all surfaces of the pre-mold, penetrated by the connector pin, to accommodate the pre-mold in the housing and exposing one of the ends of the connector pin to an outside of the housing.

2. The connector of claim 1, wherein the housing directly contacts the all surfaces of the pre-mold penetrated by the connector pin.

3. The connector of claim 1, wherein the pre-mold penetrated by the connector pin and accommodated in the housing is molded on the connector pin.

4. The connector of claim 1, wherein the pre-mold penetrated by the connector pin and accommodated in the housing has a ThermoPlastic Elastomer (TPE) material.

5. The connector of claim 4, wherein the housing is molded on the pre-mold penetrated by the connector pin and accommodated in the housing.

6. The connector of claim 5, wherein one or more edges of the pre-mold penetrated by the connector pin and accommodated in the housing are chamfered or rounded.

7. The connector of claim 5, wherein an outer surface of the pre-mold penetrated by the connector pin and accommodated in the housing has a plurality of convex portions.

8. The connector of claim 5, wherein an outer surface of the pre-mold penetrated by the connector pin and accommodated in the housing has a plurality of concave portions.

9. The connector of claim 5, wherein an outer surface of the pre-mold penetrated by the connector pin and accommodated in the housing has at least one groove.

10. The connector of claim 1, wherein the connector pin includes at least one protrusion positioned outside the pre-mold and inside the housing and protruding in a direction perpendicular to a direction in which the connector pin penetrates the pre-mold.

11. The connector of claim 10, wherein the at least one protrusion comprises a protrusion positioned outside the first surface of the pre-mold and another protrusion positioned outside the second surface of the pre-mold.

12. The connector of claim 1, wherein the housing includes a wall portion surrounding the exposed one of the ends of the connector pin.

13. The connector of claim 12, wherein the wall portion surrounding the exposed one of the ends of the connector pin is formed integrally with the housing.

14. A method of manufacturing a connector, comprising:
injection-molding a pre-mold on at least one electrically conductive connector pin such that the connector pin penetrates the pre-mold and ends of the connector pin protrude from first and second surfaces of the pre-mold, respectively, and
injection-molding a housing surrounding all surfaces of the pre-mold, penetrated by the connector pin, to accommodate the pre-mold in the housing and exposing one of the ends of the connector pin to an outside of the housing.

15. The method of claim 14, wherein the injection-molding of the housing includes injection-molding the housing on the pre-mold penetrated by the connector pin such that the housing directly contacts the all surfaces of the pre-mold.

16. The method of claim 14, wherein the injection-molding of the pre-mold on the at least one electrically conductive connector includes injection-molding the pre-mold with a ThermoPlastic Elastomer (TPE) material.

17. The method of claim 16, wherein the injection-molding of the housing includes molding the housing by insert-injecting the pre-mold penetrated by the connector pin.

18. The method of claim 14, wherein:
the connector pin includes at least one protrusion positioned outside the pre-mold and protruding in a direction perpendicular to a direction in which the connector pin penetrates the pre-mold, and
the injection-molding of the housing includes injection-molding the housing such that the at least one protrusion of the connector pin is positioned inside the housing.

19. The method of claim 16, wherein the injection-molding of the housing includes forming a wall portion surrounding the exposed one of the ends of the connector pin.

20. The method of claim 19, wherein the wall portion surrounding the exposed one of the ends of the connector pin is injection-molded integrally with the housing.
